(19) United States
(12) Patent Application Publication
(10) Pub. No.: US 2008/0027998 A1
(43) Pub. Date: Jan. 31, 2008

(54) Method and apparatus of continuous data protection for NAS

(75) Inventor: Junichi Hara, San Jose, CA (US)

Correspondence Address: SUGHRUE MION, PLLC, 401 Castro Street, Ste 220, Mountain View, CA, 94041-2007, US

(73) Assignee: HITACHI, LTD., Tokyo (JP)

(21) Appl. No.: 11/495,276

(22) Filed: Jul. 27, 2006

(51) Int. Cl. G06F 17/00; G06F 17/30

(52) U.S. Cl. 707/200; 707/103 X

(57) ABSTRACT

A system includes a NAS System and one or more NAS Clients. The NAS system manages volumes containing file system data, volumes containing snapshot (copy) of the file system data, and volumes containing journal (log) of requests sent from NAS Clients. The system takes a snapshot of the volume containing file system data periodically, and records requests to the file system data after the snapshot is taken. When the system needs to restore an image of file system data at a certain point, it restores the snapshot, and then it replays the recorded requests in order. The system protects a file system using CDP function on a storage system by implementing a function in the NAS system, which determines a time point at which each storage system operation is completed, and a function in the storage system for keeping the information in the journal.

### DESCRIPTION OF THE INVENTION

1. Field of the Invention

The present invention is related to file servers or NAS (Network Attached Storage) systems, and in particular to backup and recovery of file system data.

2. Description of the Related Art

Historically, various methods have been used to prevent loss of data in a storage volume. A typical and conventional method is to take a backup of data in the volume periodically (e.g. once a day) and write the backup to backup media (e.g. magnetic tapes). When the data in the volume needs to be restored, the data saved in the backup media is read and written to a new volume. However, this backup technique can only restore the image of the data in the volume at the time point when the backup was taken. Therefore, if the restored data is also corrupted, the backup data taken at the previous or next period needs to be restored.

Recently, storage systems having a journaling capability have emerged. Journaling is one of the methods, which can be used to prevent loss of data. In the journaling method, an image of data in a storage volume at a certain time point is taken. This image is usually called a snapshot. The history (or a journal) of subsequent changes made to the volume after the time point of the snapshot is also maintained. Restoring of the data is accomplished by applying the journal to the snapshot. In this manner, the state of the data in the volume can be restored at any point in time. Published United States patent application number US2004/0268067A1, titled “Method and Apparatus for Backup and Recovery System Using Storage Based Journaling,” which is incorporated by reference herein, discloses an exemplary storage system with journaling capability. The journaling storage system may take a snapshot of data in the storage volume periodically, and maintain a journal of the changes to the volume after each snapshot. Snapshots and journal entries are stored separately from the data volumes. The data in a volume can be restored from the snapshot and journal entries on a block level. The aforesaid technique involving protecting volume data using snapshots and journal entries is called CDP (Continuous Data Protection).

There is a difficulty, however, in deploying the CDP on network-attached storage (NAS) systems. Specifically, in NAS system architecture, the time point for restoring data needs to be specified in terms of file system operations such as deletion of the wrong file, writing to the wrong file, renaming of the wrong file, etc. Therefore, the CDP technology can be deployed to protect a NAS file system by requiring the NAS system to keep track of the completion time of each storage system operation and to provide this completion time information to the CDP system. However, the implementation of the aforesaid feature within the NAS system is a complicated task.

Therefore, what is needed is a technique for providing continuous data protection for file servers and NAS systems.

### SUMMARY OF THE INVENTION

The inventive methodology is directed to methods and systems that substantially obviate one or more of the above and other problems associated with conventional techniques for data protection.

In accordance with one aspect of the inventive concept, there is provided a computerized data storage system including a network-attached storage system and a network-attached storage client coupled to the network-attached storage system. The network-attached storage system includes a file system volume, a snapshot volume and a journal volume. The network-attached storage client is configured to issue requests to the network-attached storage system. The network-attached storage system stores data in the file system volume; stores snapshot image of the data in the file system volume in the snapshot volume; stores information on the requests in the journal volume; and in response to a restore command issued by the network-attached storage client, applies records from the journal volume to the content of the snapshot volume.

In accordance with another aspect of the inventive concept, there is provided a method including creating a journal group, which includes a file system associated with a network-attached storage and a journal volume; journaling NFS requests directed to the file system, which includes assigning a first sequence number to each journaled NFS request; and taking a snapshot of data in the file system, which includes assigning a second sequence number to the snapshot.

In accordance with yet another aspect of the inventive concept, there is provided a method a computer programming product embodied in a computer-readable medium including code for creating a journal group, which includes a file system associated with a network-attached storage and a journal volume. The inventive programming product further comprises code for journaling NFS requests directed to the file system, which involves assigning a first sequence number to each journaled NFS request; and code for taking a snapshot of data in the file system, which involves assigning a second sequence number to the snapshot.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 shows an overview of the invention.

FIG. 2 shows a system configuration.

FIG. 3 shows a module configuration.

FIG. 4 shows an example of data layout of file system.

FIG. 5 illustrates an example of logical structure of file system.

FIG. 6 illustrates a NFS request.

FIG. 7 shows a control data for journal.

FIG. 8 shows Journal Management Table.

FIG. 9 illustrates a relationship between Snapshot and Journal.

FIG. 10 illustrates a relationship between multiple snapshots and journal.

FIG. 11 shows a flowchart of starting journal.

FIG. 12 shows a flowchart of restoring data from snapshot and journal to original volume.

FIG. 13 shows a mapping table of file handle and path.

FIG. 14 shows a flowchart of making mapping information between file handle and path.

FIG. 15 shows a flowchart of replaying journal in case of restoring to a different volume.

FIG. 16 shows a flowchart of checking journal capacity.

FIG. 17 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

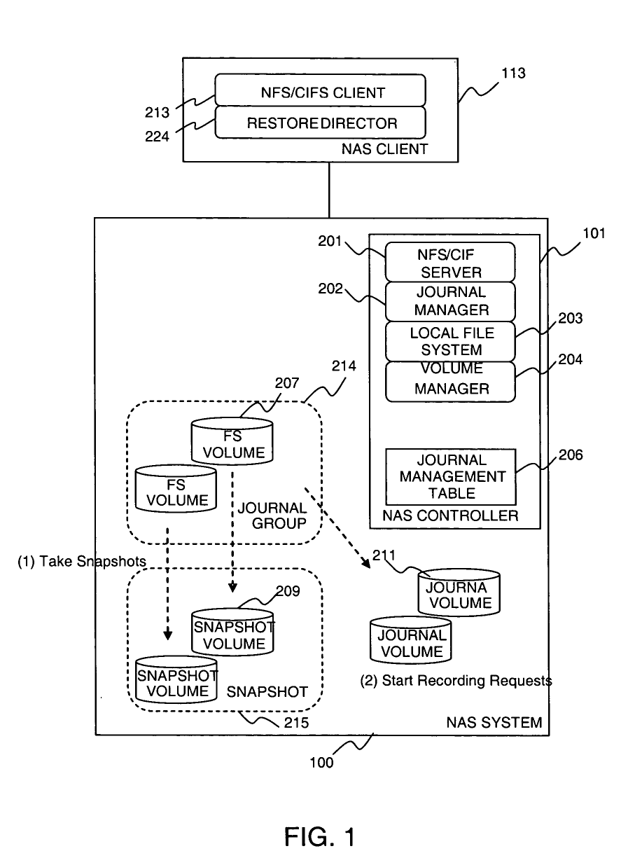

FIG. 1 provides an overview of an embodiment of the inventive technique. The inventive system illustrated in FIG. 1 includes a NAS System 100 and one or more NAS Clients 113. Each of the NAS Clients 113 includes NFS/CIFS Client 213 as well as Restore Director 224. The NAS System incorporates one or more filesystem volumes 207, which are grouped into a Journal Group 214. The NAS System 100 is operable to create a snapshot copies of the volumes 207 of the Journal Group 214 and to write the aforesaid snapshot copies to Snapshot Volumes 209, which collectively form snapshot 215. In addition, the NAS System 100 incorporates Journal Volumes 211. Additional elements of FIG. 1 will be described hereinafter in more detail with reference to other figures.

### System Configuration

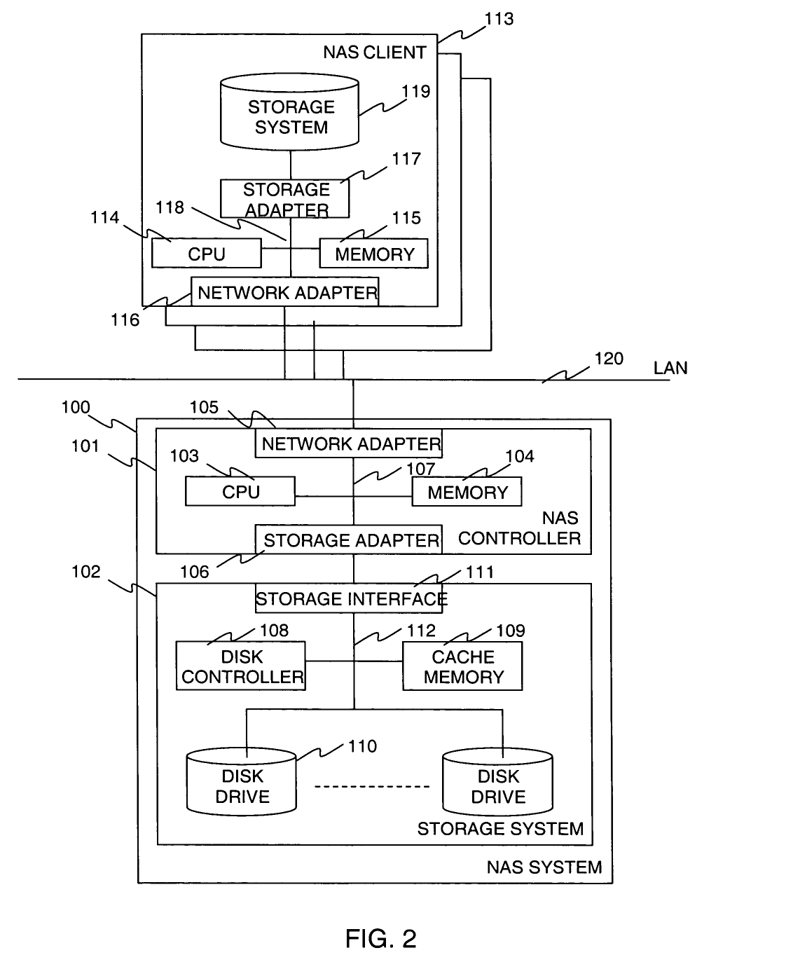

FIG. 2 illustrates an exemplary configuration of a storage system in which the techniques consistent with the principles of the present invention may be implemented. The shown system includes a NAS System 100 and one or more NAS Clients 113. The NAS System 100 includes NAS Controller 101 and Storage System 102. The NAS Controller 101 includes CPU 103, Memory 104, Network Adapter 105, and Storage Adapter 106. These components are interconnected via a Bus 107.

The Storage System 102 includes Disk Controller 108, Cache Memory 109, Disk Drives 110, and Storage Interface 111. These components are interconnected via Bus 112. The NAS Controller 101 and the Storage System 102 are interconnected via the Storage Adapter 106 and the Storage Interface 111. Various interfaces such as Fibre Channel or SCSI can be utilized to implement the Storage Interface 111. If Fibre Channel or SCSI interface is used in implementing the Storage Interface 111, a Host Bus Adapter (HBA) may be used as the Storage Adapter 106. The Storage System 102 can be externally deployed and connected to NAS Controller 101 via the aforesaid interfaces.

The NAS System 100 is connected to NAS Clients 113 via Network Adapter 105. The software applications embodying the present invention may execute on the NAS System 100 using the CPU 103 disposed within the NAS Controller 101.

Each of NAS Clients 113 comprises CPU 114, Memory 115, Network Adapter 116, Storage Adapter 117, and Storage System 119, which are interconnected via internal bus 118. Each of NAS Clients 113 is connected to NAS System 100 via Network Adapter 116. The Storage System 119 may be implemented using substantially the same components as the Storage System 102 in NAS System 100, and can be externally deployed and connected.

### Functional Diagram

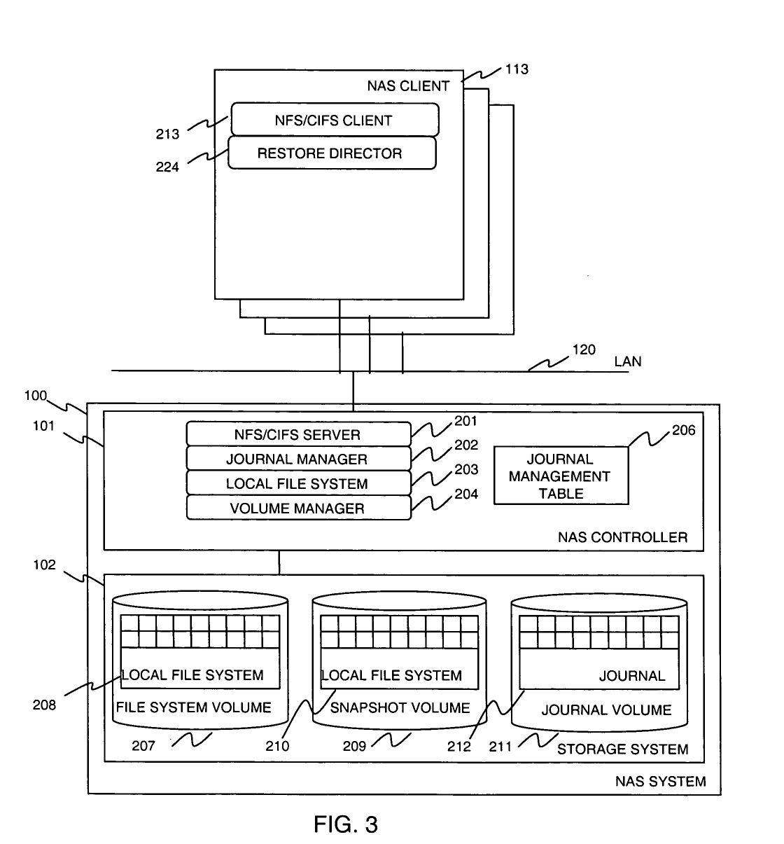

FIG. 3 provides a functional diagram of an exemplary system in accordance with the present invention. The NAS Controller 101, disposed within the NAS System 100, includes NFS/CIFS Server 201, Journal Manager 202, Local File System 203, and Volume Manager 204.

NFS/CIFS Server 201 exports files (makes the files accessible) via NFS and CIFS protocol managed by Local File System 203. Also, the NFS/CIFS Server 201 interprets requests from the NAS Clients 113, issues appropriate file I/O requests to Local File System 203, and sends back responses to NAS Clients 113. In addition, the NFS/CIFS Server 201 stores the requests in the Journal Volume 211 in accordance with instructions from the Journal Manager 202. Yet additionally, the NFS/CIFS Server 201 replays the requests stored in the Journal Volume 211 in accordance with instructions from Journal Manager 202.

The Local File System 202 receives file I/O requests from NFS/CIFS Server 200, and issues appropriate block I/O request to Volume Manager 204.

Journal Manager 202 manages snapshots and journal entries using the Journal Management Table 206. Also, it instructs Volume Manager 204 to take a snapshot of a volume, and NFS/CIFS Server 201 to take journals of requests sent from NAS Clients 113. When restoring from snapshots and journals, it instructs Volume Manager 204 to restore snapshot to the original or different volume, and NFS/CIFS Server 201 to replay the requests in Journal Volume 211.

Volume Manager 204 creates one or more Volumes 207 using one or more Disk Drives 110 in Storage System 102. Also, it takes a snapshot of a volume in accordance with the instruction from Journal Manager 202.

Each of the NAS Clients 113 includes NFS/CIFS Client 213 as well as Restore Director 224.

NFS/CIFS Client 113 sends appropriate file I/O requests via NFS and CIFS protocol to NAS System 100 in accordance with instructions from users or applications on NAS Client 113.

Restore Director 224 sends restore request to Journal Manager 202 on NAS System 100 in accordance with the instruction from users or applications on NAS Client 113.

### Snapshot Mechanism

Snapshot is a mechanism to take a point in time copy (image) of data in a storage volume. Snapshot can be implemented at various levels such as block level, file system level, etc. In one embodiment of the invention, the NAS System 100 utilizes the block level snapshot. In the aforesaid block level snapshot implementation, an image of the data stored in a volume is copied to a different volume. Therefore, if the original volume stores a file system, the data image of the entire file system is copied to a different volume.

Also, there are various methods to implement the aforesaid snapshot mechanism. Mirroring is one of the most popular implementations. In the Mirroring method, a snapshot volume having the same size as the original volume is prepared, and the snapshot volume is associated with the original volume. After the snapshot volume has been associated with the original volume, all the data in the original volume is copied to the snapshot volume. After the initial copy is completed, all the write input-output operations (I/Os) directed to the original volume are also applied to the snapshot volume. When a data image at a certain time point needs to be preserved, the aforesaid application of write I/Os to the snapshot volume is discontinued, thereby “splitting” the snapshot volume from the original volume.

### Local File System Data Structure

The Local File System is a file system used by each of the file servers or NAS systems to manage local files and directories. Each file server or NAS system can use a different Local File System.

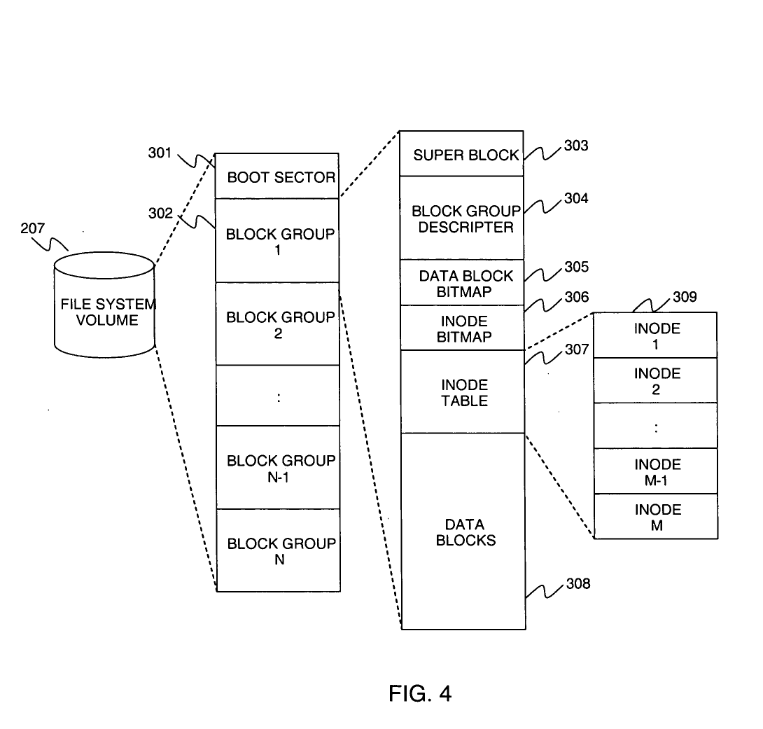

FIG. 4 illustrates the manner in which the data associated with the Local File System 203 is stored in File System Volume 207. The Boot Sector 301 of the file System Volume is provided to store boot programs operable to boot the System, if needed. The Local File System 203 does not alter the content of the Boot Sector 301. The remainder of the volume is used by Local File System 203.

The Local File System 203 divides the remainder of the volume into Block Groups 302. Each Block Group 302 includes Super Block 303, Block Group Descriptor 304, Data Block Bitmap 305, Inode Bitmap 306, Inode Tables 307, and Data Blocks 308.

Super Block 303 is used to store the location information associated with the Block Groups 302. Every Block Group 302 has the same copy of Super Block 303. Block Group Descriptor 304 stores the management information associated with the Block Group 302. The Data Block Bitmap 305 identifies Data Blocks 308, which are in use. Similarly, Inode Bitmap 306 identifies Inodes 309 in Inode Table 307, which are in use.

Inode record 309 in Inode Table 307 stores the following attributes associated with each file or directory:

Inode Number: The unique number for the Inode

File Type: Type of data storage unit associated with the Inode (file, directory, etc)

File Size: The size of the file

Access permission: Bit string expressing access permissions for user (owner), group, other

User ID: ID number of the user owning the file

Group ID: ID number of the group that the user (owner) belongs to

Create Time: The time when the file is created

Last Modify Time: The time when the file is modified

Last Access Time: The time when the file is last accessed

Block Pointer: Pointer to the data blocks where actual data is stored

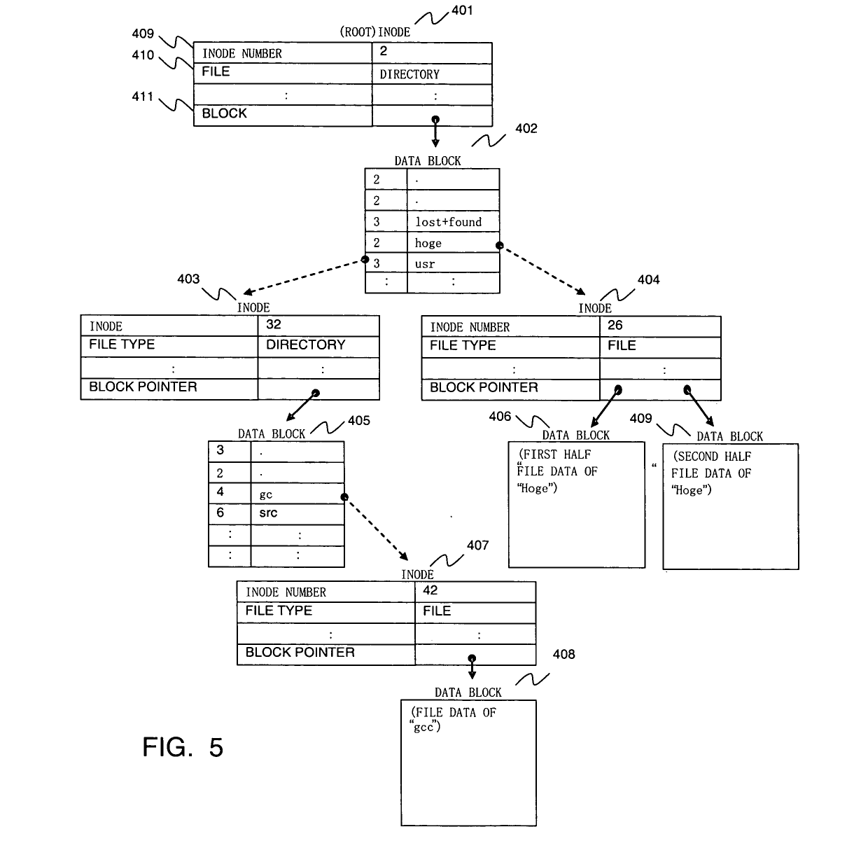

FIG. 5 illustrates the logical relationship between Inodes 401, 403, 404 and 407 and the respective Data Blocks 402, 405, 406, 408, and 409. Each Inode 401, 403, 404 and 407 can be used to indicate a file or a directory. If the Inode indicates a file (if the value of File Type field is “file”, like 404 and 407), the data block pointed from the Inode contains actual data of the file. If a file is stored in multiple Data Blocks 406 and 409, the addresses of the two Data Blocks 406 and 409 are recorded in Block Pointer field. Each Block Pointer is expressed as the logical block address (LBA) in File System Volume 207. If the Inode indicates a directory (if the value of the File Type field is “directory”, like 401 and 403), the Data Blocks pointed from the Block Pointer field store the list of Inode Numbers and Names of all files and directories in the directory corresponding to the Inode.

### File Access Protocols

There are several protocols, which allow client computers (NAS Client 113 in the shown embodiment) to access file systems managed by file servers or NAS systems (NAS System 100 in the embodiment) via LAN (Local Area Network, LAN 120 in the embodiment). NFSv3 (Network File System version 3, defined in IETF RFC1813), NFSv4 (Network File System version 4, defined in IETF RFC3530), and CIFS (Common Internet File System, developed by Microsoft Corporation) are some examples of widely used file access protocols. The embodiment of the invention will be described hereafter with NFS version 3 as an example.

### NFS Operations

NFS version 3 protocol, well known to persons of skill in the art, allows the NAS Client 113 to request the following operations for files or directories exported by the NAS System 100. In response to the requests received from the NAS Client 113, the NAS System 100 executes the procedures specified below.

Upon the receipt of the NULL request, the NAS System 100 takes no action.

Upon the receipt of the GETATTR request, the NAS System 100 reads and returns attributes of a file specified in the request.

Upon the receipt of the SETATTR request, the NAS System 100 changes the attributes of the target file as indicated in the request.

Upon the receipt of the LOOKUP request, the NAS System 100 looks up a file name or a directory name specified in the request. If found, it returns the corresponding File Handle (explained later) to the NAS Client 113.

Upon the receipt of the ACCESS request, the NAS System 100 checks access permission of a file or a directory specified in the request.

Upon the receipt of the READLINK request, the NAS System 100 reads and returns data of a symbolic link (a file storing a pointer to the other file in its data).

Upon the receipt of the READ request, NAS System 100 reads and returns data of a file specified in the request.

Upon the receipt of the WRITE request, NAS System 100 writes data to a file as specified in the request.

Upon the receipt of the CREATE request, NAS System 100 creates a new file as indicated in the request.

Upon the receipt of the MKDIR request, NAS System 100 creates a new directory as indicated in the request.

Upon the receipt of the SYMLINK request, NAS System 100 creates a new symbolic link as indicated in the request.

Upon the receipt of the MKNOD request, NAS System 100 creates a special file as indicated in the request. The special file can be a named pipe or a device file.

Upon the receipt of the REMOVE request, NAS System 100 removes a file specified in the request.

Upon the receipt of the RMDIR request, NAS System 100 removes a directory specified in the request.

Upon the receipt of the RENAME request, NAS System 100 changes a name of a file or a directory as indicated in the request.

Upon the receipt of the LINK request, NAS System 100 creates a hard link (a file or a directory pointing the same data as an existing one) as indicated in the request.

Upon the receipt of the READDIR request, NAS System 100 reads and returns data of a directory specified in the request. Data of a directory contains names of files and directories (usually called directory entries) in the specified directory.

Upon the receipt of the READDIRPLUS request, NAS System 100 reads and returns data of a directory specified in the request. It also returns file handles for each directory entry.

Upon the receipt of the FSSTAT request, NAS System 100 retrieves and returns dynamic information of a file system such as the amount of total size, the amount of free space size, etc.

Upon the receipt of the FSINFO request, NAS System 100 retrieves and returns static information of a file system such as the maximum size of READ request, WRITE request, a single file size, etc. allowed on NAS System 100.

Upon the receipt of the PATHCONF request, NAS System 100 retrieves and returns “pathconf” information of a file or a directory specified in the request. “Pathconf” information is defined in POSIX (Portable Operating System Interface for UNIX).

Upon the receipt of the COMMIT request, NAS System 100 flashes dirty data (data not yet written to the stable storage) on its cache (resides on Memory 104 in this embodiment) to the stable storage (Storage System 102 in this embodiment) so that the written data will not be lost even after NAS System 100 crashes.

### File Handle

When the NAS Client 113 issues requests to the NAS System 100, it specifies the target file or directory by its File Handle. The File Handle is a 64-byte string assigned by the NAS System 100 for each file and directory. When the NAS system 100 receives LOOKUP requests from the NAS Client 113, the NAS System 100 determines the File Handle for each file or directory so that NAS System 100 can identify the file or directory by its file handle. Internet Standard RFC1813, well known to persons of skill in the art and incorporated herein by reference, adopted by the Internet Engineering Task Force (IETF), states that the File Handle must not change even after the NAS System 100 reboots. However, the manner in which File Handle is determined is not defined in the RFC1813 and is not essential to the inventive concepts. The exact manner how file handle is generated depends on each operating system or platform.

In one widely used implementation, the File Handle is generated using the following information:

Device Number: a unique number assigned to each device such as network adapters, storage volumes, etc. managed on the system.

Inode Number: the unique number for each mode (as described hereinabove).

Because the File Handle generation software module uses Device Number and Inode Number, if a file or directory is migrated or copied to a different volume, the migrated or copied file or directory cannot be identified by the same File Handle as the one associated with the original file or directory.

### NFS Request

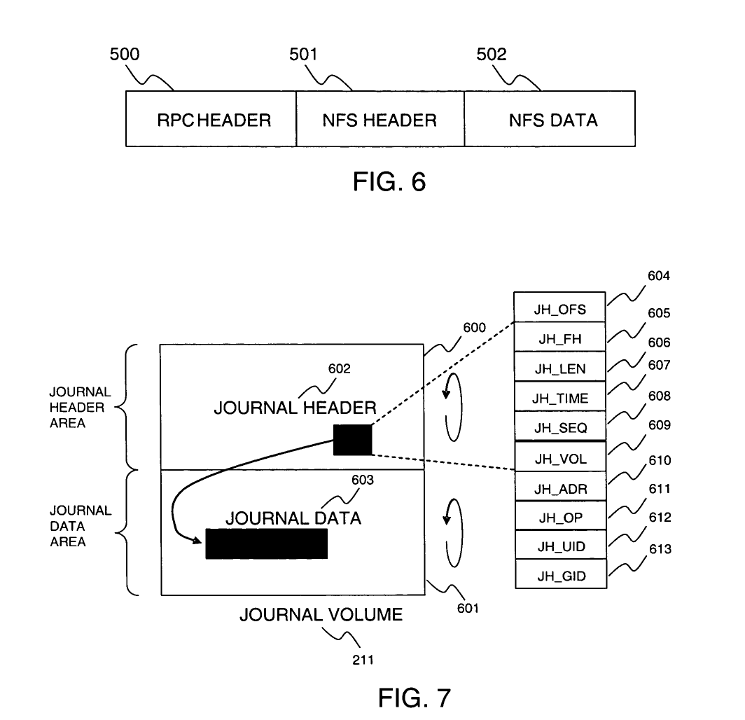

As shown in FIG. 6, each NFS request includes the following three parts of data, which will be described in detail below: RPC Header 500, NFS Header 501, and NFS Data 502.

### RPC Header 500

In one embodiment of the invention, RPC Header 500 includes following information.

XID: a unique number for the request. This number is determined on NAS Client 113.

Reply Flag: if this field is 0, it means the RPC header is for calling a procedure on NAS System 100. If 1, it's for replying.

RPC Version: a fixed number to indicate the version of RPC protocol. Usually, “2” is set in this field.

RPC Program Number: a fixed number “100003” is set in this field to indicate that the request is based on NFS protocol.

RPC Program Version Number: the number “3” is set in this field to indicate that the request is based on version 3 of NFS protocol.

RPC Procedure Number: this field is used to specify which procedure the request indicates. For example, 7 is set in this field to specify the request is calling WRITE procedure.

Authentication Information: this field is used to specify what kind of authentication method is to be used. Also, UID (User ID) and GID (Group ID) are contained in this field. UID and GID will be used in NAS System 100 to identify that the requesting user has the right authority to do the procedure on the target file or directory.

### NFS Header 501

The contents of NFS Header 501 depend on the type of the NFS request. For example, if the request is a WRITE operation, the following information is included in this part.

File Handle: The File Handle identifying the file to which the data in the NFS Data portion is to be written. The File Handle is commonly contained in the NFS Header of the request associated with operations on files and directories. The File Handle enables the NAS System 100 to identify the target files and directories.

Offset: The position within the file at which the write is to begin.

Count: The number of bytes of data to be written.

Stable Flag: This field specifies how NAS System 100 treats the written data. For example, if this field is contains value 2, the NAS System 100 must flash the dirty data within its cache to the Storage System 102, before returning the result of WRITE operation to the NAS Client 113.

### NFS Data 502

Like the contents of the NFS header 501, the contents of NFS Data 502 also depend on the type of the NFS request. For example, the NFS Data portion 502 includes the data to be written to the storage, if the NFS request involves the WRITE operation. Some NFS requests such as LOOKUP, GETATTR, and the like do not have the NFS Data portion 502.

### Journal Group

In accordance with one embodiment of the inventive concept, a Journal Group 214 is defined, see FIG. 1. Specifically, the File System Volumes 207 are organized into the Journal Group 214, which is the smallest unit of File System Volumes 207, where journaling of NFS requests from NAS Client 113 to the Local File System 208 is guaranteed. The associated journal records the order of requests from the NAS Client 113 to the Local File System 208 in a proper sequence. The journal data produced by the journaling activity can be stored in one or more Journal Volumes 211.

### Control Data for Journal

FIG. 7 illustrates the data used in an implementation of journaling of NFS requests. When a request from the NAS Client 113 is received by the NAS System 100, a journal record is generated in response. The journal record includes a Journal Header 602 and Journal Data 603. The Journal Header 602 contains information about the corresponding Journal Data 603. The Journal Data portion 603 incorporates the entire NFS request, which consists of RPC Header 500, NFS Header 501, and NFS Data 502, as was described hereinbefore.

As illustrated in FIG. 7, each Journal Header 604 incorporates the following fields.

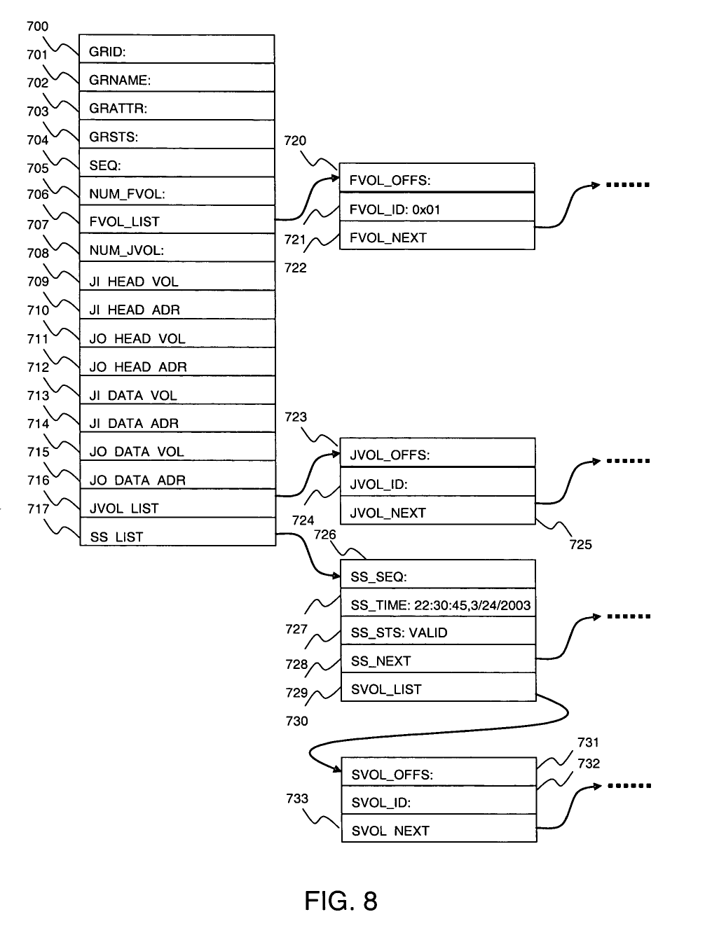

JH_OFS 604: this field identifies a particular File System Volume 207 in the Journal Group 214. The File System Volumes are ordered starting with the 0th File System Volume, followed by the 1st File System Volume, the 2nd File System Volume and so on. The volume offset numbers might be 0, 1, 2, etc. JH_OFS 604 identifies the specific File System Volume 207 in the Journal group 214, which is the target of the request. The aforesaid offset number corresponds to the FVOL_OFFS record 720 shown in FIG. 8, and is determined when the journal entry is created in response to a request from the NAS Client 113.

JH_FH 605: this field identifies a particular file or directory, which is the target of the request. The aforesaid targeted file or directory are identified using the appropriate File Handle. The File Handle can be retrieved from the NFS Header 501 portion of the request.

JH_LEN 606: this field carries information on the total length of the request.

JH_TIME 607: this field represents the time when the request is received at the NAS System 100. JH_TIME 607 field can include the calendar day, hour, minute, second, and even millisecond of the request. This time can be provided by either the NAS System 100 or the NAS Client 113.

JH_SEQ 608: this field represents a sequence number assigned to each request. Every sequence number within a given Journal Group 214 is unique. The sequence number is assigned to a journal entry when it is created.

JH_VOL 609: this field identifies the Journal Volume 211 associated with the Journal Data 603. The identifier is indicative of the Journal Volume 211 containing the Journal Data 603. It is noted that the Journal Data 603 can be stored in a Journal Volume 211 that is different from the Journal Volume 211 containing the Journal Header 602.

JH_ADR 610: this field provides the beginning address of the Journal Data 603 in the associated Journal Volume 211 containing the Journal Data 603.

JH_OP 611: this field provides the RPC Procedure Number specified in the RPC Header of the request.

JH_UID 612: this field contains the user identifier (UID) specified in the RPC Header of the request.

JH_GID 613: this field contains the group identifier (GID) specified in RPC Header of the request.

The fields such as JH_OP 611, JH_UID 612, and JH_GID 613 are not necessarily included in the Journal Header 602. However, those fields can assist the NAS System 100 in speedy search for the correct recovery point, when the user requested recovery based on operations, users, or groups.

### Requests to be Journaled

In order to enable the users to recover the image of the Local File System 208 at any desired time point, in accordance with an embodiment of the inventive concept, all the NFS requests are journaled. However, in order to reduce the required capacity for the Journal Volumes 211, it is possible to reduce the number of the journaled NFS requests.

In one particular implementation, requests involving operations such as NULL, ACCESS, FSINFO, FSSTAT, PATHCONF and the like are not stored in the journal because these operations do not involve changing of any data within the File System Volumes 207.

In one particular implementation, only the requests that make changes to the data associated with files and directories, such as SETATTR, WRITE, CREATE, MKDIR, SYMLINK, MKNOD, REMOVE, RMDIR, RENAME, LINK, and COMMIT are being journaled. In this case, however, users cannot specify the recovery image of the Local File System 208 using the file access time, because READ operation also changes the access time of files, and the READDIR operation changes the access time of directories.

### Journal Management Table

FIG. 8 illustrates specifics of the Journal Management Table 206. In order to manage the Journal Header Area 600, and the Journal Data Area 601, pointers for each of the above areas are required. As mentioned hereinabove, the Journal Management Table 206 maintains configuration information associated with Journal Groups 214 as well as information on the relationships within the Journal Group 214, the associated Journal Volumes 211, and the Snapshot Image 209.

The Journal Management Table 206 shown in FIG. 8 illustrates an exemplary management table and its contents. The illustrated Journal Management Table 206 stores the following information.

GRID 700: this record identifies a particular Journal Group 214. The group ID is assigned by the Journal Manager 202 in the NAS System 100 when an administrator of the NAS System 100 defines the Journal Group 214.

GRNAME 701: this field describes the Journal Group 214 using a human recognizable identifier. The group name is input by an administrator of the NAS System 100 and stored in the aforesaid field by the Journal Manager 202 when the administrator defines the particular Journal Group 214.

GRATTR 702: this field involves two attributes—MASTER and RESTORE. The MASTER attribute identifies the Journal Group 214, which is being journaled. The RESTORE attribute indicates that the journal group is being restored from journals.

GRSTS 703: this record can be used to indicate two mutually exclusive states—ACTIVE and INACTIVE.

SEQ 704: this record contains a counter, which serves as the source of sequence numbers used in the Journal Header 602. When creating a new journal record, the value of the SEQ record 704 is read and assigned to the new journal record. Subsequently, the value in the SEQ record 704 is incremented and written back to this field.

NUM_FVOL 705: this record represents the number of File System Volumes 207 contained in the Journal Group 214.

FVOL_LIST 706: this field lists the File System Volumes 207 in the Journal Group 214. In an embodiment of the inventive concept, FVOL_LIST 706 is a pointer to a first entry of a data structure, which holds the File System Volume information as illustrated in FIG. 8. Each File System Volume information record comprises FVOL_OFFS 720, FVOL_ID 721, and FVOL_NEXT 722.

FVOL_OFFS 720: this field represents an offset value of a particular File System Volume 207 in the Journal Group 214. For example, if the Journal Group 214 comprises three File System Volumes 207, the offset values could be 0, 1 and 2. The offset value is assigned to each File System Volume 207 by the Journal Manager 202 when the File System Volume 207 is added to the Journal Group 214 by the administrator of the NAS System 100.

FVOL_ID 721: this field uniquely identifies the File System Volume 207 within the entire NAS System 100. Also, when users or administrators of the NAS System 100 add a new File System Volume 207, they specify a volume to be added as the File System Volume 207 using the volume identifier. It should be also noted that identifiers JVOL_ID and SVOL_ID are based on the same principle.

FVOL_NEXT 722: this field contains a pointer to a data structure holding information for the next File System Volume 207 in the Journal Group 214. This field has value of NULL if there is no next volume.

NUM_JVOL 707: this record represents the number of Journal Volumes 211 that are provided to store the Journal Header 602 and the Journal Data 603 associated with the Journal Group 214.

JI_{—HEAD}_VOL 708: this record identifies the Journal Volume 211 that contains the Journal Header Area 600 storing the next new Journal Header 602.

JI_HEAD_ADR 709: this record identifies an address of the location within the Journal Volume 211, where the next Journal Header 602 will be stored.

JO_HEAD_VOL 710: this field identifies the Journal Volume 211, which stores the Journal Header Area 600 containing the oldest Journal Header 602.

JO_HEAD_ADR 711: this field identifies an address of the location of the Journal Header 602 within the Journal Header Area 600 containing the oldest Journal Header 602.

JI_DATA_VOL 712: this field identifies the Journal Data Area 601 in which the next Journal Data 603 will be written.

JI_DATA_ADR 713: this field identifies the specific address in the Journal Data Area 601 where the next Journal Data 603 will be stored.

JO_DATA_VOL 714: this field identifies the Journal Volume 211 storing the Journal Data Area 601, which contains the data of the oldest Journal Data 603.

JO_DATA_ADR 715: this field identifies the address of the location of the oldest Journal Data 603 within the Journal Data Area 601.

JVOL_LIST 716: this field contains a list of Journal Volumes 211 associated with a particular Journal Group 214. In one embodiment of the invention, JVOL_LIST 716 is a pointer to a data structure storing information on the Journal Volumes 211. As shown in FIG. 8, each data structure comprises JVOL_OFFS 723, JVOL_ID 724, and JVOL_NEXT 725.

JVOL_OFS: this record represents an offset value associated with a particular Journal Volume 211 within a given Journal Group 214. For example, if a Journal Group 214 is associated with two Journal Volumes 211, then the Journal Volumes might be identified using offset values of 0 and 1.

JVOL_ID: this field uniquely identifies the Journal Volume 211 within the NAS System 100. It should be noted that identifiers FVOL_ID and SVOL_ID are based on the same principle.

JVOL_NEXT: this field represents a pointer to the next data structure entry pertaining to the next Journal Volume 211 associated with the Journal Group 214. This field will have a NULL value if there is not the next one.

SS_LIST 717: this field represents a list of Snapshot Images 210 associated with a given Journal Group 214. In this particular implementation, SS_LIST 717 is a pointer to snapshot information data structure, as shown in FIG. 8. Each snapshot information data structure includes the following information.

SS_SEQ 726: this field represents a sequence number, which is assigned to the snapshot when the snapshot is taken.

SS_TIME 727: this field stores information on the time point when the snapshot was taken.

SS_STS 728: this field carries status information associated with each snapshot; valid values include VALID and INVALID.

SS_NEXT 729: this field contains a pointer to the next snapshot information data structure. The value of this field is NULL when there is no next snapshot. Each snapshot information data structure also includes a list of Snapshot Volumes (SVOL_LIST) 730, which store the Snapshot Images 210. As shown in FIG. 8, a pointer (SVOL_LIST) 730 to a snapshot volume information data structure is stored in each snapshot information data structure. Each snapshot volume information data structure includes the following records.

SVOL_OFFS 731: this record represents an offset value, which identifies a Snapshot Volume 209 containing at least a portion of the Snapshot Image 210. It is possible that the Snapshot Image 210 will be segmented or otherwise partitioned and stored in more than one Snapshot Volumes 209. In one embodiment of the invention described herein, the aforesaid offset value identifies the i-th Snapshot Volume 209 containing a portion (segment, partition, etc) of the Snapshot Image 210.

SVOL_ID 732: this field uniquely identifies the Snapshot Volume 209 in the NAS System 100. It should be noted that identifiers FVOL_ID and JVOL_ID are based on the same principle.

SVOL_NEXT 733: this record represents a pointer to the next snapshot volume information data structure for a specific snapshot image. This field will have a NULL value if there is no next snapshot volume information data structure.

### Relationship Between Journal Entries and Snapshots

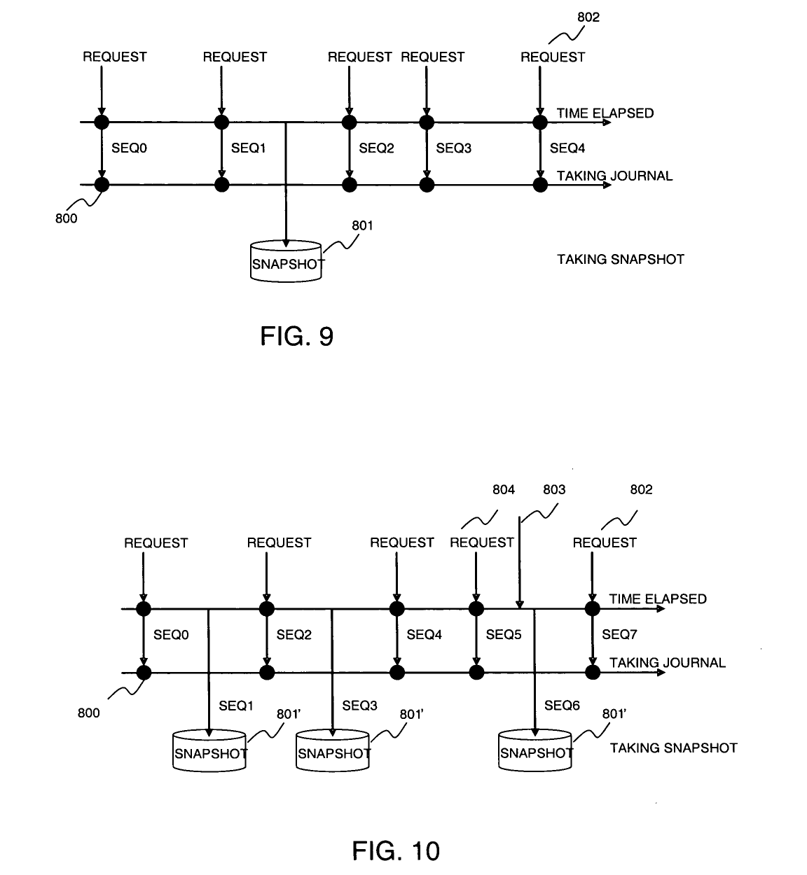

FIG. 9 illustrates the relationship between journal entries and snapshots. The snapshot 801 represents the first snapshot image of the File System Volumes 207 belonging to a Journal Group 214. Note that journal entries 800 having sequence numbers SEQ0 and SEQ1 have been created. These two entries represent journal entries corresponding to two requests. The contents of these entries show that journaling has been initiated at a point in time, which is prior to the time of the snapshot. Thus, at a time corresponding to the sequence number SEQ2, the Journal Manager 202 initiates the taking of a snapshot, and because the journaling has been previously initiated, any requests occurring during the taking of the snapshot are journaled. Thus, the requests 802 associated with the sequence numbers SEQ3 and higher indicate that those requests are being journaled. It should be noted herein that the journal entries identified by sequence numbers SEQ0 and SEQ1 can be discarded or otherwise ignored.

### Instructing NAS System to Restore Data

When a user or an application executing on the NAS Client 113 instructs the Restore Director 224 to restore a certain Journal Group 214, a user or an application can specify the restore point by specifying the time when the desired state of data existed by specifying the last performed operation. When the Restore Director 224 sends the restore request to the NAS System 113, it also provides the NAS System 113 with at least the target Journal Group ID or Name in addition to the criteria specifying the restore point.

When the NAS System 113 receives the restore request, it searches snapshot and journal entries using the criteria specified in the restore request and, upon finding the appropriate records, uses them to restore the image of the data.

For example, if a user or an application executing on the NAS Client 113 specifies the restore time point 803 in FIG. 10, the NAS System 113 restores the latest snapshot before the time point 803, and replays the requests between the time of the snapshot and the time point 803.

If a user or an application executing on the NAS Client 113 specifies the request 804, the NAS System 113 restores the latest snapshot before the request 804, and replays the request between the time of the snapshot and the time of the specified request 804.

### Restoring from Snapshot and Journal

Restoring data typically requires recovering the data image of the Local File System 202 at a specific time or point to the original File System Volume 207 or some other different volume. Generally, this is accomplished by applying one or more journal entries to a snapshot that was taken earlier in time relative to the journal entries. Applying journal records may involve updating or overwriting a part of the snapshot according to one or more journal entries.

In one particular embodiment of the invention, the value of the SEQ record 704 is incremented upon each request and is assigned to a journal entry or to a snapshot. Therefore, the journal entries that can be applied to a selected snapshot can be easily identified using the aforesaid SEQ value. Specifically, the proper journal entries should have the associated sequence number (JH_SEQ) 608, which is greater than the sequence number (SS_SEQ) 726 associated with the selected snapshot.

For example, a user or an application may specify a particular time point to the NAS System 100 using the Restore Director 224. Presumably, the specified time point is earlier than the time at which the data in the File System Volume 207 was lost or otherwise corrupted. Thus, the time field SS_TIME 727 corresponding to each snapshot is searched until a time earlier than the target time is found. Next, the Journal Headers 602 in the Journal Header Area 600 are searched, beginning from the “oldest” Journal Header 602. The oldest Journal Header can be identified by the aforesaid “JO_” records 710, 711, 714, and 715 in the Journal Management Table 206. The Journal Headers 602 are searched sequentially in the area 600 for the first header with sequence number JH_SEQ 608 greater than the sequence number SS_SEQ 726 associated with the selected snapshot. The selected snapshot is updated by applying each journal entry, one at a time, to the snapshot in sequential order, thus reproducing the sequence of requests. The aforesaid application of the journal entries is equivalent to replaying the requests represented by the journal entries, which were targeted to the Local File System 208, a snapshot of which is stored in the Snapshot Volume 209.

This continues for as long as there exist journal entries having the value of the time field JH_TIME 607 prior to the target time. The update process terminates with the first journal entry with time field value 607 after the target time. In case of restoring the image to the original File System Volume 207, first the image of data in the Snapshot Volume 209 is copied to the File System Volume 207. Then, the journaled requests, which were directed to the original Local File System 208, are replayed on the original File System Volume 207.

In accordance with one aspect of an embodiment of the inventive concept, a single snapshot is taken. All journal entries subsequent to that snapshot can then be applied to the aforesaid snapshot to reconstruct the state of the data at any specified time. In accordance with another aspect of the embodiment of the inventive concept, multiple snapshots 801′ are taken. Each taken snapshot and each journal entry is assigned a sequence number in the order in which the object (snapshot or journal entry) is recorded. It can be appreciated that because there typically will be many journal entries 800 recorded between each snapshot 801′, having multiple snapshots provides for quicker recovery times for restoring data. First, the snapshot closest in time to the target recovery time would be selected. The journal entries made subsequent to the snapshot could then be applied to restore the state of the data at a desired time point.

### In Case of Restoring to Original Volume

When restoring the file system image to the original File System Volume 207, the original File Handles specified in the journal are valid for the restored file system image because Inode Numbers and Device Numbers will not change. Therefore, restoring to the original File System Volume 207 is achieved simply by copying snapshot image in the Snapshot Volume 209 to the original File System Volume 207, and then replaying the journaled requests.

### Making Journal

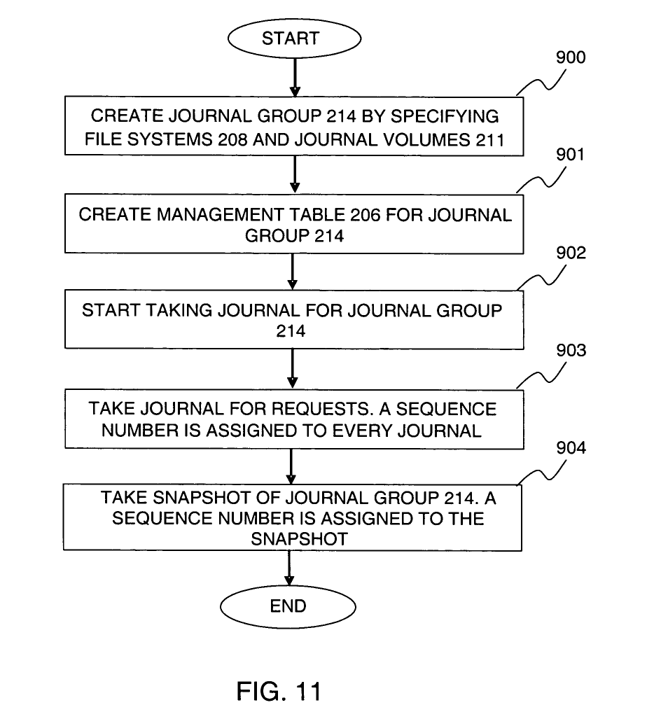

FIG. 11 shows a flowchart of an exemplary process for initiating the journaling operation. The specific steps of the aforesaid exemplary process will be described hereinbelow in detail.

Step 900: an administrator specifies the name of the Journal Group 214, the target File System Volumes 207, and the Journal Volumes 211 to be used in connection with the Journal Group 214.

Step 901: NAS System 100 creates the Journal Management Table 206.

Step 902: NAS System 100 starts taking journal for the Journal Group 214.

Step 903: Each time NAS System 100 makes a journal entry it assigns a sequence number for each such journal entry.

Step 904: When NAS System 100 takes a snapshot of the Journal Group 214, it also assigns a sequence number to that snapshot.

### Checking Journal

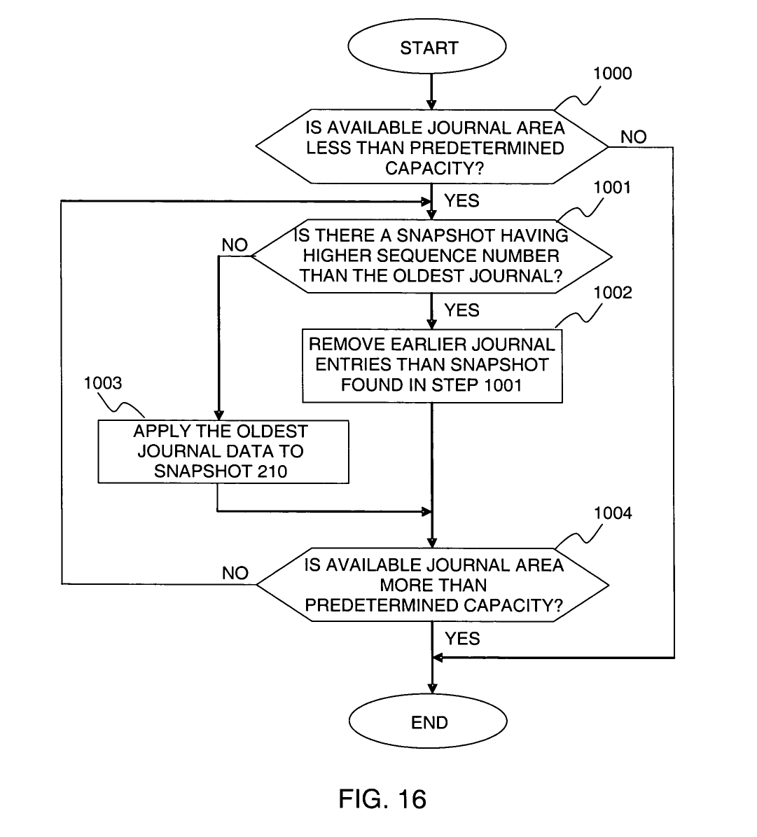

FIG. 16 shows a flowchart of an exemplary embodiment of a process for checking capacity of the journal. Using this process, the Journal Manager 202 periodically reduces the number of journal entries to free up storage space in the journal volume.

Step 1000: the NAS System 100 checks whether the available journal area is less than a predetermined capacity. If it is, the process continues to Step 1001. Otherwise, the process terminates.

Step 1001: the NAS System 100 checks whether there is a snapshot having a higher sequence number than the sequence number of the oldest journal record. If there is, the process continues to Step 1002. Otherwise, the process proceeds with Step 1003.

Step 1002: the NAS System 100 removes the journal entries with sequence numbers earlier than the sequence number of the snapshot found in Step 1001. The removed entries are no longer required because they will never be used to restore data image.

Step 1003: the NAS System 100 applies the oldest journal entry to the snapshot of Local File System 210.

Step 1004: the NAS System 100 checks whether the available journal area exceeds the predetermined capacity. If it does, the process terminates. Otherwise, the process goes back to Step 1001.

In this example, the Journal Manager 202 applies and removes journal entries only if the remaining journal capacity drops below the predetermined capacity. In another embodiment, the system applies and removes the journal entries taken before a predetermined time to reduce the size of the journal.

### Restore Procedure

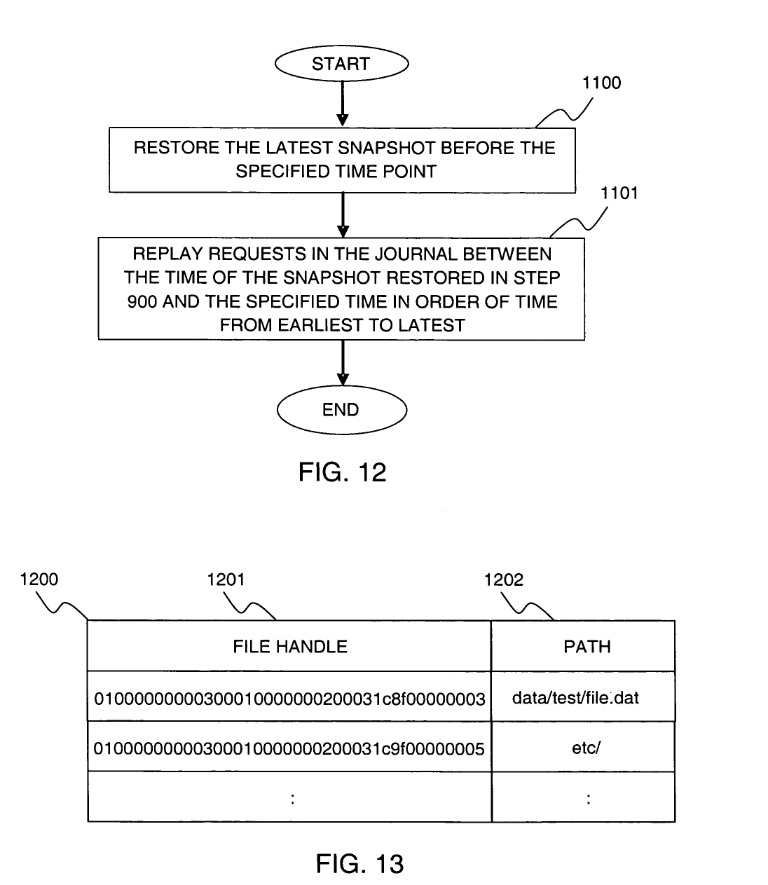

FIG. 12 shows a flowchart of a process for restoring data using the snapshot and journal when a user or an application executing on the NAS Client 113 specifies a recovery time point using the Restore Director 224 coupled to the NAS System 100.

Step 1100: the NAS System 100 restores the latest snapshot before the specified time point.

Step 1101: the NAS System 100 replays the journaled requests between the time of the snapshot restored at Step 1100 and the specified time point in time order from earliest to latest.

### Restoring Image to Different Volume

When the file system image needs to be restored to a volume, which is different from the original File System Volume 207, the File Handles specified in the journal are not valid for the restored file system image because the Device Number for the target restore volume will not be the same as the Device Number of the original volume. Therefore, restoring to a different volume is achieved by keeping mapping information between File Handle and Path. Typical NFS servers keep such mapping information in a database. However, once a File Handle becomes invalid, the mapping information for the File Handle will be removed from the database. Therefore, the NAS System 100 needs to record the mapping information separately.

### Mapping Between File Handle and Path

FIG. 13 shows the example mapping information 1200 between File Handle 1201 and Path 1202.

### Creating Mapping Information Between File Handle and Path

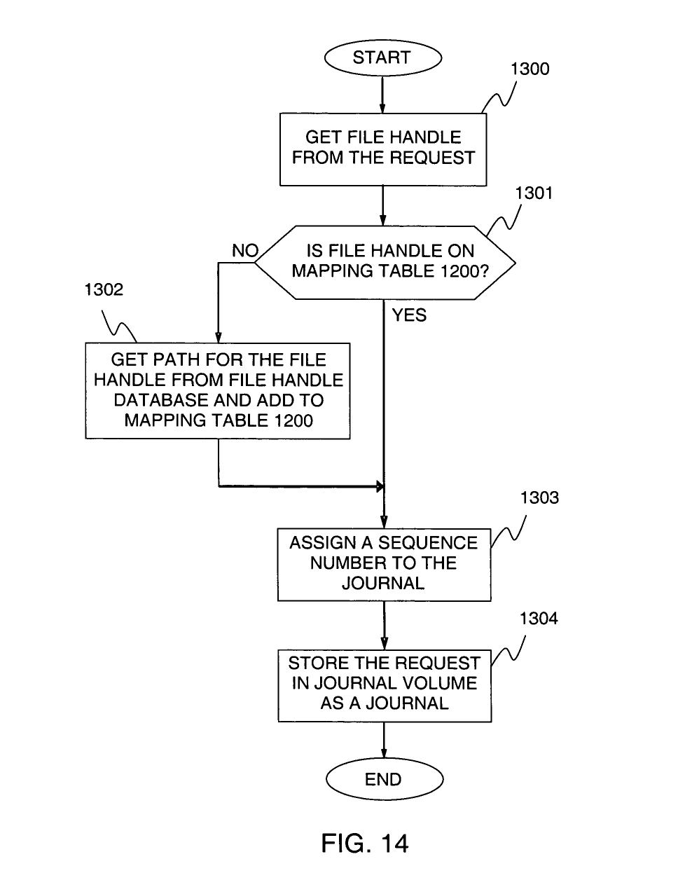

FIG. 14 shows a flowchart representing an exemplary embodiment of a process for creating mapping information between File Handle and Path. This process is performed at Step 903 of the process shown in FIG. 11.

Step 1300: When the NAS System 100 makes a new journal entry corresponding to a new request, it retrieves the File Handle from the request.

Step 1301: the NAS System 100 checks if there is already an entry for the File Handle within the Mapping Table 1200. If the entry exists, the process proceeds to Step 1303. Otherwise, it proceeds to Step 1302.

Step 1302: the NAS System 100 retrieves the Path corresponding to the File Handle from a database managed by the NAS System 100.

Step 1303: the NAS System 100 assigns a sequence number to the journal entry.

Step 1304: the NAS System 100 stores the new journal entry corresponding to the request.

### Restoring

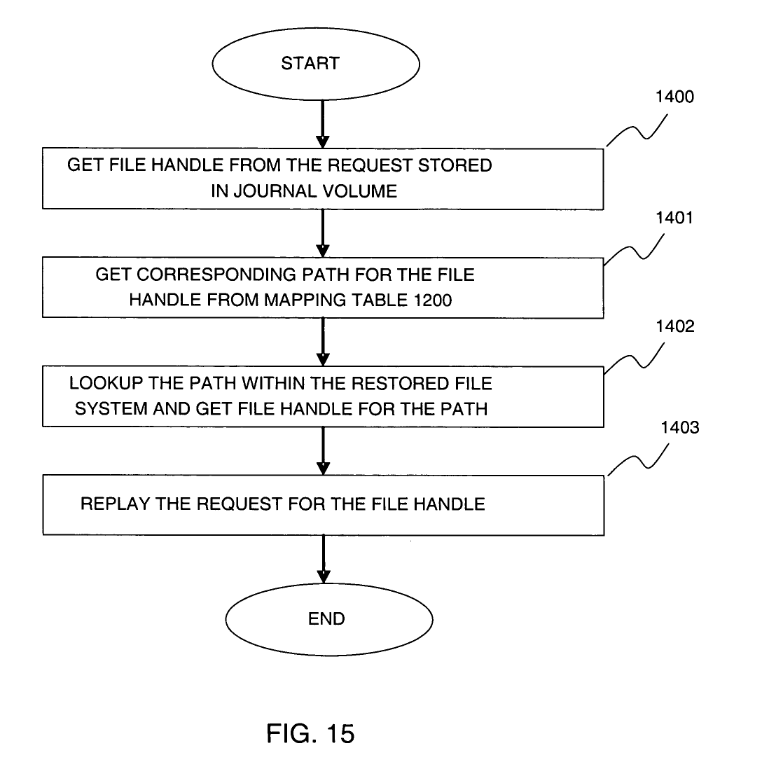

FIG. 15 shows a flowchart illustrating an exemplary procedure used in replaying journal entries in case of restoring the data image to a different volume. This process is performed at Step 1101 of the process shown in FIG. 12.

Step 1400: the NAS System 100 retrieves the File Handle from the journal to be replayed.

Step 1401: the NAS System 100 retrieves the Path corresponding to the File Handle from the Mapping Table 1200.

Step 1402: the NAS System 100 looks up the Path within the restored file system image, and retrieves the File Handle corresponding to the Path.

Step 1403: the NAS System 100 replays the request using the retrieved File Handle.

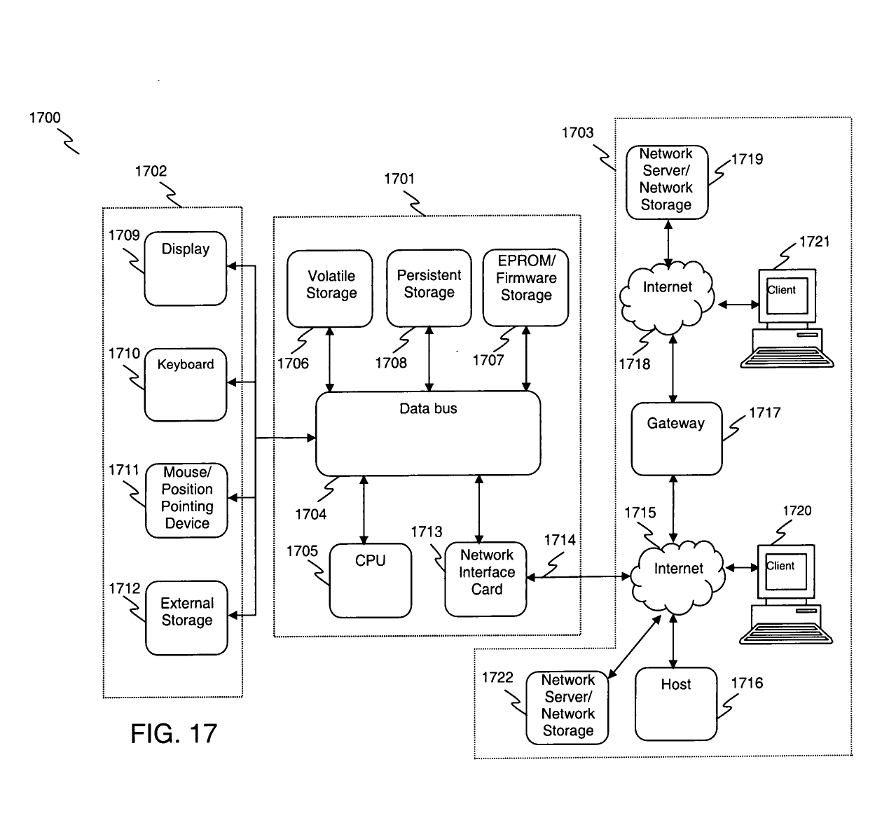

FIG. 17 is a block diagram that illustrates an embodiment of a computer/server system 1700 upon which an embodiment of the inventive methodology may be implemented. The system 1700 includes a computer/server platform 1701, peripheral devices 1702 and network resources 1703.

The computer platform 1701 may include a data bus 1704 or other communication mechanism for communicating information across and among various parts of the computer platform 1701, and a processor 1705 coupled with bus 1701 for processing information and performing other computational and control tasks. Computer platform 1701 also includes a volatile storage 1706, such as a random access memory (RAM) or other dynamic storage device, coupled to bus 1704 for storing various information as well as instructions to be executed by processor 1705. The volatile storage 1706 also may be used for storing temporary variables or other intermediate information during execution of instructions by processor 1705. Computer platform 1701 may further include a read only memory (ROM or EPROM) 1707 or other static storage device coupled to bus 1704 for storing static information and instructions for processor 1705, such as basic input-output system (BIOS), as well as various system configuration parameters. A persistent storage device 1708, such as a magnetic disk, optical disk, or solid-state flash memory device is provided and coupled to bus 1701 for storing information and instructions.

Computer platform 1701 may be coupled via bus 1704 to a display 1709, such as a cathode ray tube (CRT), plasma display, or a liquid crystal display (LCD), for displaying information to a system administrator or user of the computer platform 1701. An input device 1710, including alphanumeric and other keys, is coupled to bus 1701 for communicating information and command selections to processor 1705. Another type of user input device is cursor control device 1711, such as a mouse, a trackball, or cursor direction keys for communicating direction information and command selections to processor 1704 and for controlling cursor movement on display 1709. This input device typically has two degrees of freedom in two axes, a first axis (e.g., x) and a second axis (e.g., y), that allows the device to specify positions in a plane.

An external storage device 1712 may be connected to the computer platform 1701 via bus 1704 to provide an extra or removable storage capacity for the computer platform 1701. In an embodiment of the computer system 1700, the external removable storage device 1712 may be used to facilitate exchange of data with other computer systems.

The invention is related to the use of computer system 1700 for implementing the techniques described herein. In an embodiment, the inventive system may reside on a machine such as computer platform 1701. According to one embodiment of the invention, the techniques described herein are performed by computer system 1700 in response to processor 1705 executing one or more sequences of one or more instructions contained in the volatile memory 1706. Such instructions may be read into volatile memory 1706 from another computer-readable medium, such as persistent storage device 1708. Execution of the sequences of instructions contained in the volatile memory 1706 causes processor 1705 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1705 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 1708. Volatile media includes dynamic memory, such as volatile storage 1706. Transmission media includes coaxial cables, copper wire and fiber optics, including the wires that comprise data bus 1704. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 1705 for execution. For example, the instructions may initially be carried on a magnetic disk from a remote computer. Alternatively, a remote computer can load the instructions into its dynamic memory and send the instructions over a telephone line using a modem. A modem local to computer system 1700 can receive the data on the telephone line and use an infra-red transmitter to convert the data to an infra-red signal. An infra-red detector can receive the data carried in the infra-red signal and appropriate circuitry can place the data on the data bus 1704. The bus 1704 carries the data to the volatile storage 1706, from which processor 1705 retrieves and executes the instructions. The instructions received by the volatile memory 1706 may optionally be stored on persistent storage device 1708 either before or after execution by processor 1705. The instructions may also be downloaded into the computer platform 1701 via Internet using a variety of network data communication protocols well known in the art.

The computer platform 1701 also includes a communication interface, such as network interface card 1713 coupled to the data bus 1704. Communication interface 1713 provides a two-way data communication coupling to a network link 1714 that is connected to a local network 1715. For example, communication interface 1713 may be an integrated services digital network (ISDN) card or a modem to provide a data communication connection to a corresponding type of telephone line. As another example, communication interface 1713 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 1713 sends and receives electrical, electromagnetic or optical signals that carry digital data streams representing various types of information.

Network link 1713 typically provides data communication through one or more networks to other network resources. For example, network link 1714 may provide a connection through local network 1715 to a host computer 1716, or a network storage/server 1722. Additionally or alternatively, the network link 1713 may connect through gateway/firewall 1717 to the wide-area or global network 1718, such as an Internet. Thus, the computer platform 1701 can access network resources located anywhere on the Internet 1718, such as a remote network storage/server 1719. On the other hand, the computer platform 1701 may also be accessed by clients located anywhere on the local area network 1715 and/or the Internet 1718. The network clients 1720 and 1721 may themselves be implemented based on the computer platform similar to the platform 1701.

Local network 1715 and the Internet 1718 both use electrical, electromagnetic or optical signals that carry digital data streams. The signals through the various networks and the signals on network link 1714 and through communication interface 1713, which carry the digital data to and from computer platform 1701, are exemplary forms of carrier waves transporting the information.

Computer platform 1701 can send messages and receive data, including program code, through the variety of network(s) including Internet 1718 and LAN 1715, network link 1714 and communication interface 1713. In the Internet example, when the system 1701 acts as a network server, it might transmit a requested code or data for an application program running on client(s) 1720 and/or 1721 through Internet 1718, gateway/firewall 1717, local area network 1715 and communication interface 1713. Similarly, it may receive code from other network resources.

The received code may be executed by processor 1705 as it is received, and/or stored in persistent or volatile storage devices 1708 and 1706, respectively, or other non-volatile storage for later execution. In this manner, computer system 1701 may obtain application code in the form of a carrier wave. Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc. Moreover, other implementations of the invention will be apparent to those skilled in the art from consideration of the specification and practice of the invention disclosed herein. Various aspects and/or components of the described embodiments may be used singly or in any combination in the computerized storage system with CDP functionality. It is intended that the specification and examples be considered as exemplary only, with a true scope and spirit of the invention being indicated by the following claims.

What is claimed is:

1. A computerized data storage system comprising:
a. a network-attached storage system comprising a file system volume, a snapshot volume and a journal volume; and
b. a network-attached storage client coupled to the network-attached storage system and operable to issue requests to the network-attached storage system, wherein the network-attached storage system is operable to:
i. store data in the file system volume;
ii. store snapshot image of the data in the file system volume in the snapshot volume;
iii. store information on the requests in the journal volume; and
iv. in response to a restore command issued by the network-attached storage client, to apply records from the journal volume to the content of the snapshot volume.

2. The computerized data storage system of claim 1, wherein the requests are NFS requests.

3. The computerized data storage system of claim 1, wherein the network-attached storage system is operable to store information in the journal volume only on requests, which involve modification of the data.

4. The computerized data storage system of claim 1, wherein the journal volume comprises journal records comprising journal header and journal data.

5. The computerized data storage system of claim 1, further comprising a file handle store operable to store a mapping between file handle and path of data stored by the file system volume.

6. The computerized data storage system of claim 5, wherein the network-attached storage system is further operable to obtain the file handle from the requests, verify whether the obtained file handles are stored in the file handle store and, if not, to obtain the path and to store the file handle and the path to the file handle store.

7. The computerized data storage system of claim 5, wherein upon restore of the data in the file system volume to a new volume, the network-attached storage system is further operable to use the contents of the file handle store to generate file handle information for the new volume.

8. The computerized data storage system of claim 7, wherein upon restore of the data in the file system volume to a new volume, the network-attached storage system is further operable to:
a. Get file handle from the request information stored in the journal volume;
b. Get corresponding path for the file handle from the file handle store;
c. Lookup the path within a restored file system; and
d. Replay a request for the file handle.

9. The computerized data storage system of claim 1, wherein the network-attached storage system is further operable to assign a sequence number to each request information stored in the journal volume.

10. The computerized data storage system of claim 1, wherein the network-attached storage system is further operable to determine the available journal capacity and, if the determined journal capacity is below a predetermined threshold, to delete at least some journal records.

11. The computerized data storage system of claim 1, wherein the network-attached storage system is further operable to determine the available snapshot volume capacity and, if the determined snapshot volume capacity is below a predetermined threshold, to delete at least some snapshots.

12. A method comprising:
a. Creating a journal group, the journal group comprising a file system associated with a network-attached storage and a journal volume;
b. Journaling NFS requests directed to the file system, wherein journaling comprises assigning a first sequence number to each journaled NFS request; and
c. Taking a snapshot of data in the file system, wherein taking a snapshot comprises assigning a second sequence number to the snapshot.

13. The method of claim 12, further comprising:
a. Receiving a restore command; and
b. In response to the received restore command, applying at least a portion of the journaled NFS requests to the snapshot to restore data image.

14. The method of claim 12, wherein the restore command specifies the restore data time.

15. The method of claim 12, wherein the journaled NFS requests involve modification of the data.

16. The method of claim 12, wherein the NFS requests are journaled in a journal volume storing journal records comprising journal header and journal data.

17. The method of claim 16, further comprising determining available journal volume capacity and, if the determined journal volume capacity is below a predetermined threshold, deleting at least some journal records.

18. The method of claim 13, further comprising creating a mapping between a file handle and path of data stored by the file system.

19. The method of claim 18, further comprising:
i. obtaining the file handle from the NFS requests,
ii. verifying whether the obtained file handles are stored in the file handle store and, if not, obtaining the path and storing the file handle and the path.

20. The method of claim 18, wherein applying comprises using the mapping between a file handle and path to generate file handle information for a new volume to which the file system is restored.

21. The method of claim 18, further comprising:
a. obtaining file handle from the journaled NFS requests;
b. obtaining corresponding path for the file handle from the mapping;
c. performing lookup of the path within a restored file system; and
d. replaying a request for the file handle.

22. The method of claim 18, wherein the network-attached storage system is further operable to determine the available journal capacity and, if the determined journal capacity is below a predetermined threshold, to delete at least some journal records.

23. The method of claim 18, further comprising:
a. storing the snapshot in a snapshot volume;
b. determine the available snapshot volume capacity; and
c. if the determined snapshot volume capacity is below a predetermined threshold, deleting at least some stored snapshots.

24. A computer programming product embodied in a computer-readable medium, comprising:
a. Code for creating a journal group, the journal group comprising a file system associated with a network-attached storage and a journal volume;
b. Code for journaling NFS requests directed to the file system, wherein journaling comprises assigning a first sequence number to each journaled NFS request; and
c. Code for taking a snapshot of data in the file system, wherein taking a snapshot comprises assigning a second sequence number to the snapshot.

25. The computer programming product of claim 24, further comprising:
a. Code for receiving a restore command; and
b. Code for applying at least a portion of the journaled NFS requests to the snapshot to restore data image in response to the received restore command.

26. The computer programming product of claim 24, wherein the restore command specifies the restore data time.

27. The computer programming product of claim 24, wherein the journaled NFS requests involve modification of the data.

28. The computer programming product of claim 24, wherein the NFS requests are journaled in a journal volume storing journal records comprising journal header and journal data.

29. The computer programming product of claim 24, further comprising code for determining available journal volume capacity and, if the determined journal volume capacity is below a predetermined threshold, deleting at least some journal records.

30. The computer programming product of claim 24, further comprising code for creating a mapping between a file handle and path of data stored by the file system.

31. The computer programming product of claim 24, further comprising:
i. Code for obtaining the file handle from the NFS requests,
ii. Code for verifying whether the obtained file handles are stored in the file handle store and, if not, obtaining the path and storing the file handle and the path.

32. The computer programming product of claim 24, wherein applying comprises using the mapping between a file handle and path to generate file handle information for a new volume to which the file system is restored.

33. The computer programming product of claim 24, further comprising:
a. Code for obtaining file handle from the journaled NFS requests;
b. Code for obtaining corresponding path for the file handle from the mapping;
c. Code for performing lookup of the path within a restored file system; and
d. Code for replaying a request for the file handle.

34. The computer programming product of claim 24, further comprising:
a. Code for storing the snapshot in a snapshot volume;
b. Code for determine the available snapshot volume capacity; and, if the determined snapshot volume capacity is below a predetermined threshold, deleting at least some stored snapshots.
